(19) United States
(12) Patent Application Publication
(10) Pub. No.: US 2026/0177867 A1
(43) Pub. Date: Jun. 25, 2026

(54) DISPLAY DEVICE AND HEAD-UP DISPLAY DEVICE

(71) Applicant: Nippon Seiki Co., Ltd., Niigata (JP)

(72) Inventors: Yohei Fukino, Niigata (JP); Yujiro Inoue, Niigata (JP)

(21) Appl. No.: 19/398,497

(22) Filed: Nov. 24, 2025

(30) Foreign Application Priority Data
Dec. 25, 2024 (JP) 2024-228786
Mar. 24, 2025 (JP) 2025-048001

(51) Int. Cl. G02F 1/1347; G02B 27/01; G02F 1/1335

(52) U.S. Cl. CPC G02F 1/1347; G02B 27/0101; G02F 1/133601; G02F 1/133607; G02B 2027/0118

(57) ABSTRACT

A display device includes an illumination device that emits illumination light, a liquid crystal display panel that includes an image display area where an image is displayed and a non-display area where no image is displayed, and that receives the illumination light and emits display light, and a monochrome liquid crystal panel that is located between the illumination device and the liquid crystal display panel, and that sets, to a black display state, an area corresponding to the non-display area and sets, to a white display state, an area corresponding to the image display area.

### TECHNICAL FIELD

The present disclosure relates to a display device and a head-up display device.

### BACKGROUND ART

A head-up display device described in Patent Document 1 includes a display that displays a display image including a first display image, a second display image, and a third display image, and a backlight that illuminates each of the first display image, the second display image, and the third display image in a different illumination area.

### PRIOR ART DOCUMENT

### Patent Document

Patent Document 1: Japanese Patent No. 6299523

### SUMMARY OF INVENTION

### Technical Problem

In the configuration described in Patent Document 1, the illumination area (dimming zone) is large compared to the pixel size of each display image, and thus the contrast of each display image may decrease due to halation at the outer peripheral portion of each display image. Here, to match the dimming zone to the pixel size, it is necessary to arrange light emitting diodes (LEDs) and the like at a finer pitch. However, the finer the arrangement pitch, the lower the light utilization efficiency, which is the efficiency of the luminance of the dimming zone relative to the power consumption of the LEDs.

As described above, it is difficult to increase image contrast by setting the dimming zone to match the pixel size of each display image, because of poor light utilization efficiency.

The present disclosure has been made in consideration of the above-described circumstances, and an object thereof is to provide a display device and a head-up display device that can more appropriately increase image contrast in accordance with the shape of a display image.

### Solution to Problem

To achieve the above object, a display device according to a first aspect of the present disclosure includes, an illumination device that emits illumination light, a display panel that includes an image display area where an image is displayed and a non-display area where no image is displayed, and that receives the illumination light and emits display light, and a light-transmission/light-blocking switching panel that is located between the illumination device and the display panel, and that sets, to a light-blocking state, an area corresponding to the non-display area and sets, to a light-transmitting state, an area corresponding to the image display area.

To achieve the above object, a head-up display device according to a second aspect of the present disclosure projects, onto a projection target member, the display light emitted by the display device, to display a projection image being an enlarged representation of an image displayed on the display panel.

### Advantageous Effects of Invention

According to the present disclosure, it is possible to more appropriately increase image contrast in accordance with the shape of a display image.

### BRIEF DESCRIPTION OF DRAWINGS

FIG. 1 is a schematic cross-sectional view of a head-up display device with a cross optical system, according to a first embodiment of the present disclosure.

FIG. 2 is a schematic cross-sectional view of a display device according to the first embodiment of the present disclosure, as viewed in the horizontal direction.

FIG. 3 illustrates a schematic diagram of an image display area in a display surface according to the first embodiment of the present disclosure (the upper part), and a schematic diagram of light sources and dimming zones according to the first embodiment of the present disclosure (the lower part).

FIG. 4 is a schematic cross-sectional view of a head-up display device with a non-cross optical system, according to a variation of the present disclosure.

FIG. 5 is a schematic cross-sectional view of a display device according to a variation of the present disclosure, as viewed in the horizontal direction.

FIG. 6 is a schematic front view illustrating a liquid crystal display panel according to the first embodiment of the present disclosure.

FIG. 7 is a schematic front view illustrating light sources and dimming zones according to the first embodiment of the present disclosure.

FIG. 8 is a schematic front view illustrating a monochrome liquid crystal panel according to the first embodiment of the present disclosure.

FIG. 9 is a schematic cross-sectional view of a display device according to a comparative example, as viewed in the horizontal direction.

FIG. 10 is a schematic front view illustrating a monochrome liquid crystal panel according to the comparative example.

FIG. 11 is a schematic front view illustrating the liquid crystal display panel according to the first embodiment of the present disclosure.

FIG. 12 is a schematic cross-sectional view illustrating a liquid crystal display panel, a monochrome liquid crystal panel, and a diffuser plate according to a second embodiment of the present disclosure, as viewed in the horizontal direction.

FIG. 13 is an enlarged schematic cross-sectional view illustrating the liquid crystal display panel, the monochrome liquid crystal panel, and the diffuser plate according to the second embodiment of the present disclosure, as viewed in the horizontal direction.

FIG. 14 is an enlarged schematic cross-sectional view illustrating a liquid crystal display panel, a monochrome liquid crystal panel, and a diffuser plate according to a variation of the present disclosure, as viewed in the horizontal direction.

FIG. 15 is a schematic cross-sectional view illustrating a liquid crystal display panel, a monochrome liquid crystal panel, and a diffuser plate according to a variation of the present disclosure, as viewed in the horizontal direction.

FIG. 16 a schematic view illustrating a liquid crystal display panel and a monochrome liquid crystal panel according to a variation of the present disclosure, as viewed in a parallel light traveling direction.

### DESCRIPTION OF EMBODIMENTS

### First Embodiment

A display device and a head-up display device according to a first embodiment of the present disclosure will be described with reference to the drawings.

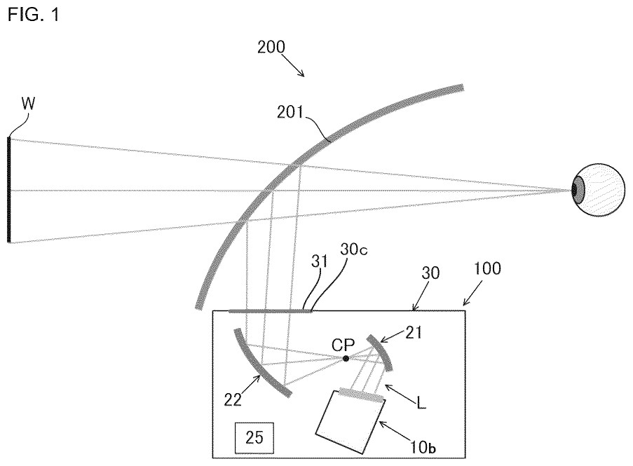

As illustrated in FIG. 1, a head-up display device 100 is installed in a dashboard of a vehicle 200. The head-up display device 100 emits display light L that represents an image, toward a windshield 201 that is a projection target member of the vehicle 200, and displays a virtual image W by the display light L reflected by the windshield 201. The virtual image W is displayed in a rectangular display area that is long in a left-right direction and short in an up-down direction when viewed from a viewer.

The head-up display device 100 includes a display device 10b, a first mirror 21, a second mirror 22, a control unit 25, and a housing 30.

The housing 30 is formed in a box shape and made of a light-blocking resin or metal, and houses the display device 10b and the mirrors 21 and 22. The housing 30 has an opening portion 30c formed to face the windshield 201 in a height direction. The housing 30 includes a window portion 31 that is fitted into the opening portion 30c and formed in a plate shape. The window portion 31 is made of a light-transmitting resin such as an acrylic resin to transmit the display light L.

The first mirror 21 and the second mirror 22 forms a relay optical system that reflects the display light L from the display device 10b to guide the display light L to the windshield 201.

The first mirror 21 reflects the display light L emitted by the display device 10b toward the second mirror 22. The first mirror 21 is a correction mirror, and is a concave mirror that is concavely curved along the height direction of the vehicle and extends linearly along a width direction of the vehicle. The first mirror 21 may be curved concavely or convexly in the width direction of the vehicle.

The first mirror 21 reflects the display light L from the display device 10b toward the second mirror 22 such that the display light L crosses at a cross point CP when viewed in the width direction of the vehicle 200. The cross point CP is located between the first mirror 21 and the second mirror 22 in the optical path of the display light L. The display light L converges from the first mirror 21 toward the cross point CP, and diverges from the cross point CP toward the second mirror 22. That is, the display light L forms an image between the first mirror 21 and the second mirror 22 in the height direction.

The second mirror 22 is a concave mirror that reflects the display light L from the display device 10b toward the windshield 201.

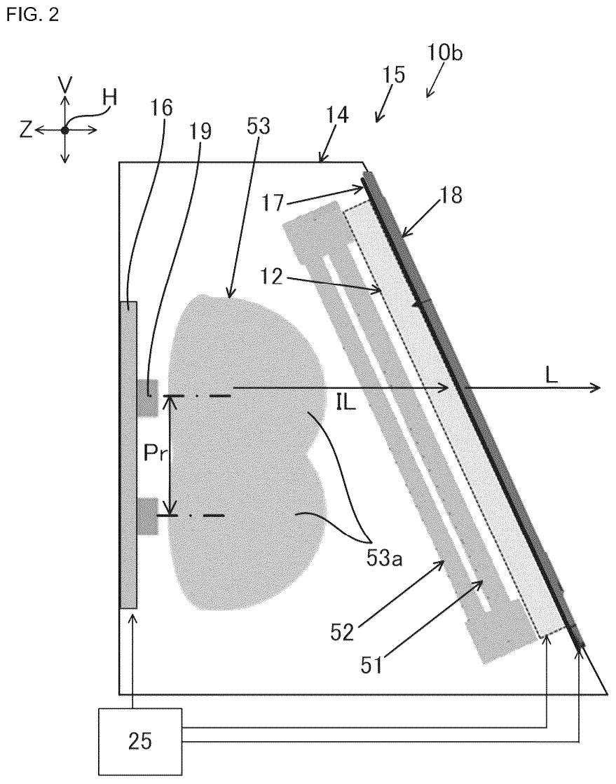

As illustrated in FIG. 2, the display device 10b includes a liquid crystal display panel 18 and an illumination device 15 that illuminates the liquid crystal display panel 18. The illumination device 15 includes a case 14, a substrate 16, a light diffusing member 17, a plurality of light sources 19, and first to third lenses 51 to 53.

In the following description, a horizontal direction H is a direction corresponding, in terms of the optical path, to the left-right direction (the width direction of the vehicle) of the virtual image W seen by the viewer, and a vertical direction V is a direction corresponding, in terms of the optical path, to the up-down direction of the virtual image W seen by the viewer. The horizontal direction H and the vertical direction V are perpendicular to each other and are also perpendicular to a parallel light traveling direction Z in which illumination light IL collimated by the third lens 53 travels.

The case 14 is formed in a rectangular tube shape and made of a light-blocking resin, metal, or the like. The case 14 houses the substrate 16 and the first to third lenses 51 to 53. A liquid crystal display panel 18 is arranged to close an opening portion 14a of the case 14.

The substrate 16 has a plate shape extending along the horizontal direction H and the vertical direction V.

The plurality of light sources 19 are mounted on a surface of the substrate 16 facing the third lens 53. Each of the light sources 19 is, for example, an LED. Specifically, the plurality of light sources 19 are arranged in the vertical direction V and the horizontal direction H to form a matrix.

The liquid crystal display panel 18 has a display surface 18a that receives the illumination light IL from each of the light sources 19 that has passed through the first to third lenses 51 to 53, and that displays an image (an intermediate image). The display surface 18a is located on a surface of the liquid crystal display panel 18 from which the display light L is emitted, and has a rectangular shape that is long in the horizontal direction H and short in the vertical direction V. The display light L representing an image is emitted from the display surface 18a of the liquid crystal display panel 18 toward the second mirror 22. The liquid crystal display panel 18 is a thin film transistor (TFT) liquid crystal panel.

The control unit 25 includes a central processing unit (CPU), a graphics display controller (GDC), a read only memory (ROM), a random access memory (RAM), and the like. The control unit 25 controls the display device 10b, for example, the plurality of light sources 19 and the liquid crystal display panel 18.

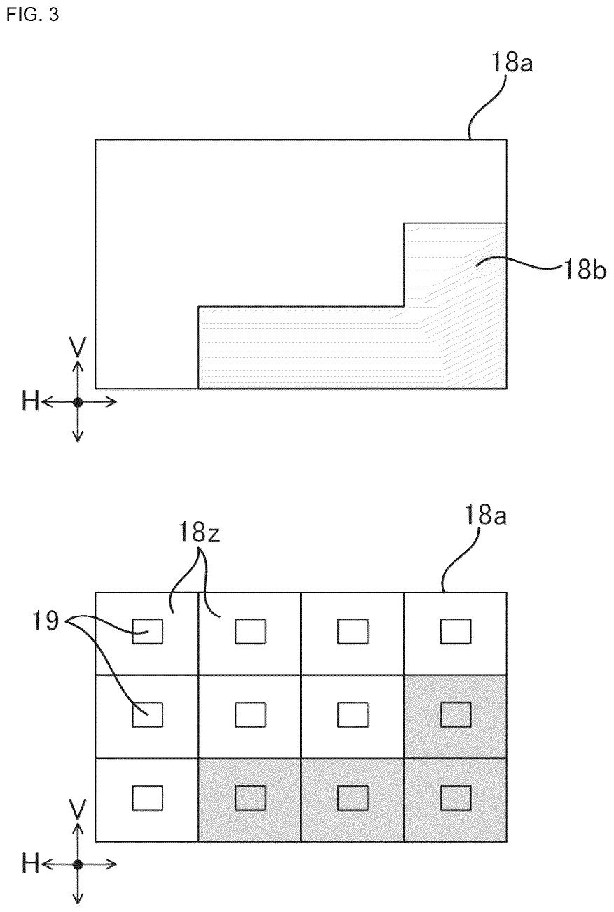

The control unit 25 has a local dimming function that separately adjusts, in accordance with the content of the image displayed on the display surface 18a, the brightness of each of plurality of dimming zones 18z that are formed by dividing the display surface 18a in the vertical direction V and the horizontal direction H, as illustrated in the lower part of FIG. 3. One or more of the light sources 19 (LEDs) are associated with each of the dimming zone 18z. The control unit 25 turns on only one or more of the dimming zones 18z of the display surface 18a that correspond to an image display area 18b (see the upper part of FIG. 3) where content is displayed, and turns off the remaining dimming zones 18z of the display surface 18a that does not correspond to the image display area 18b.

Although the control unit 25 in the present embodiment has a local dimming function, the control unit 25 may not have the local dimming function and may turn on or off all of the light sources 19 simultaneously.

As illustrated in FIG. 2, the first to third lenses 51 to 53 are arranged in the order, the third lens 53, the second lens 52, and the first lens 51, from the side close to the light source 19. The illumination light IL from the light source 19 passes through the third lens 53, the second lens 52, and the first lens 51 in this order in the thickness direction thereof.

The first to third lenses 51 to 53 are each made of a transparent optical resin or optical glass, and have a rectangular plate shape that is long in the horizontal direction H and short in the vertical direction V.

The third lens 53 collimates the light emitted from the light source 19 into light traveling in the parallel light traveling direction Z. The third lens 53 includes a plurality of convex lens portions 53a. The plurality of convex lens portions 53a are arranged in a matrix to correspond one-to-one to the light sources 19 described above.

For example, the convex lens portion 53a has a square shape when viewed in the parallel light traveling direction Z, and the length of one side of this square is set to 6 mm or less, for example, 5.6 mm.

The third lens 53 may not be limited to a lens as long as it is a collimating means, and may be a reflector.

The first lens 51, the second lens 52 and the liquid crystal display panel 18 are arranged in parallel to each other and inclined not to be perpendicular to the parallel light traveling direction Z when viewed from the horizontal direction H.

The light diffusing member 17 is a diffuser plate that diffuses the illumination light IL from the first lens 51 and emits the light to the liquid crystal display panel 18. The light diffusing member 17 may be any optical member that has the function of diffusing light, and may have a surface formed by a bead material or a fine uneven structure, or may be formed by a dot sheet or a transmissive milky white sheet, for example. The first lens 51 and the second lens 52 are provided to distribute the illumination light IL in accordance with the display surface 18a and further with the viewer's eyebox.

In particular, in the present embodiment, practically fine dimming zones are provided by using a monochrome liquid crystal panel.

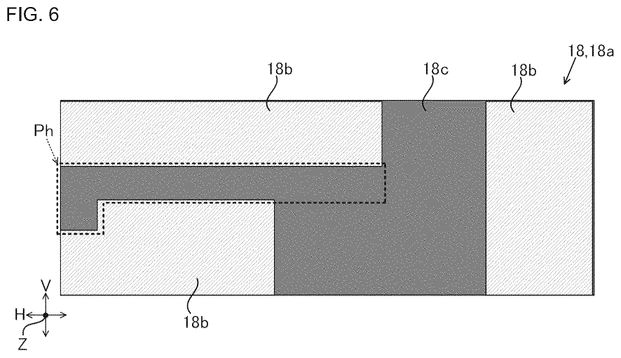

As illustrated in FIG. 6, in addition to the case 14, the substrate 16, the light diffusing member 17, the plurality of light sources 19, and the first to third lenses 51 to 53, which are described above, the illumination device 15 of the display device 10b further includes a monochrome liquid crystal panel 12 provided between the light diffusing member 17 and the first lens 51.

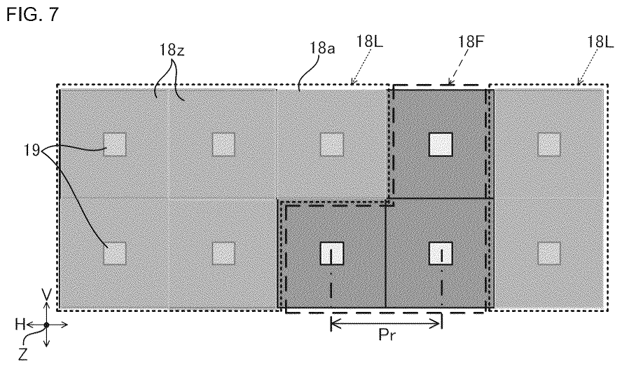

The monochrome liquid crystal panel 12 is a segmented liquid crystal display (LCD). The monochrome liquid crystal panel 12 has a shutter function that blocks part of the illumination light IL from the first lens 51 such that the image display areas 18b (see FIG. 6) of the liquid crystal display panel 18 are surrounded when viewed in the parallel light traveling direction Z. By using the monochrome liquid crystal panel 12 to block light in a part of the dimming zone 18z (see FIG. 7), it is possible to practically make the dimming zone 18z finer in accordance with the outer shape of the image display area 18b.

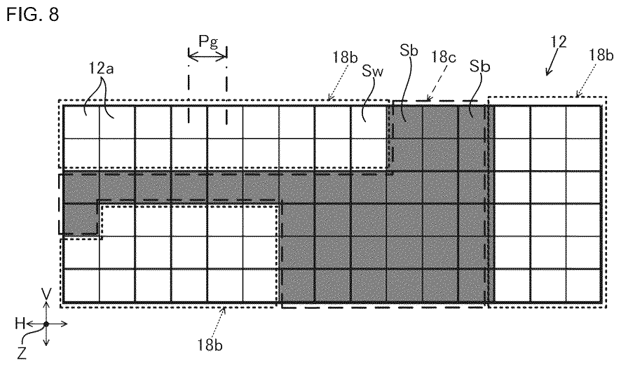

As illustrated in FIG. 8, the monochrome liquid crystal panel 12 includes a plurality of pixels 12a arranged in the vertical direction V and the horizontal direction H to form a matrix. Each of the pixels 12a has a square shape. A pitch Pg of the pixels 12a is smaller than a pitch Pr of the convex lens portions 53a. The pitch Pr of the convex lens portions 53a is the same as the pitch of the light sources 19. Under the control of the control unit 25, the light transmittance of each of the pixels 12a of the monochrome liquid crystal panel 12 is switched between 100% and 0%. When the light transmittance of the pixel 12a is 100%, the pixel 12a is in a white display state Sw where light can be transmitted. When the light transmittance of the pixel 12a is 0%, the pixel 12a is in a black display state Sb where light is blocked.

As illustrated in FIG. 7, each of the dimming zones 18z is sized to include a plurality of pixels 12a when viewed in the parallel light traveling direction Z. One dimming zone 18z corresponds to 9 pixels 12a, which forms a matrix with 3 rows and 3 columns. Each of the dimming zones 18z has, for example, a square shape having a length and a width of 10 to 12 mm. To practically make the dimming zone 18z finer in accordance with the outer shape of the image display area 18b, one or more of the plurality of pixels 12a corresponding to the dimming zone 18z to be turned on are set to the black display state Sb, and the rest are set to the white display state Sw. In this example, one dimming zone 18z corresponds to 9 pixels 12a, which forms a matrix with 3 rows and 3 columns, but other configurations may be used. For example, one dimming zone 18z may correspond to 4 pixels 12a, which forms a matrix with 2 rows and 2 columns, 16 pixels 12a, which forms a matrix with 4 rows and 4 columns, 25 pixels 12a, which forms a matrix with 5 rows and 5 columns, or 36 pixels 12a, which forms a matrix with 6 rows and 6 columns.

In one example of the present embodiment, the number of the plurality of light sources 19 (the plurality of dimming zones 18z) and the number of the plurality of convex lens portions 53a are both 10, and the light sources 19 and the convex lens portions 53a are arranged in matrices with 2 horizontal rows and 5 vertical columns. Note that the number of the plurality of dimming zones 18z and the number of the plurality of convex lens portions 53a are not limited to 10. In an example, 4 dimming zones 18z and 4 convex lens portions 53a may be provided to form matrices with 2 horizontal rows and 2 vertical columns. In another example, nine dimming zones 18z and nine convex lens portions 53a may be provided to form matrices with 3 horizontal rows and 3 vertical columns.

As illustrated in FIGS. 8, 90 pixels 12a are arranged to form a matrix with 6 horizontal rows and 15 vertical columns. The number of plurality of pixels 12a is not limited to 90, and thus, for example, 128 pixels may be arranged to form a matrix with 8 horizontal rows and 16 vertical columns. In the present embodiment, the first and second lenses 51 and 52 may be any of the various lenses disclosed in the first embodiment. In an example, the first lens 51 is a Fresnel lens, and the second lens 52 is a lenticular lens.

As illustrated in FIG. 6, the display surface 18a of the liquid crystal display panel 18 includes the image display area 18b that displays an image and a non-display area 18c that does not display an image and serves as a background. The positions, sizes, or shapes of the image display area 18b and the non-display area 18c is varied in accordance with the display content of the display surface 18a. The image display area 18b may have a shape that does not include one or more of the dimming zones 18z when viewed from the parallel light traveling direction Z.

The operation of the display device 10b when the image display area 18b and the non-display area 18c are set in the display surface 18a as illustrated in FIG. 6 will be described.

In this case, as illustrated in FIG. 7, turned-on areas 18L formed by one or more of all the dimming zones 18z is turned on, and a turned-off area 18F formed by the rest of the dimming zones 18z is turned off. The entire turned-off area 18F overlaps with the non-display area 18c. A part Ph of the turned-on area 18L overlaps with the non-display area 18c, while the remaining part of the turned-on area 18L overlaps with the image display area 18b.

As illustrated in FIG. 8, one or more of the plurality of pixels 12a of the monochrome liquid crystal panel 12 which correspond to the non-display area 18c are set to the black display state Sb, and one or more of the plurality of pixels 12a which correspond to the image display area 18b are set to the white display state Sw. That is, the black display state Sb is formed in the area overlapping with the turned-off area 18F and the part Ph of the turned-on area 18L overlapping with the non-display area 18c (see FIG. 6). This allows the monochrome liquid crystal panel 12 to block the illumination light IL from the turned-on area 18L in a manner that matches the outer shape of the image display area 18b. Therefore, halation at the outer peripheral portion of the image display area 18b is suppressed. Therefore, the image contrast of the display surface 18a can be increased, and the display quality of the image can be improved.

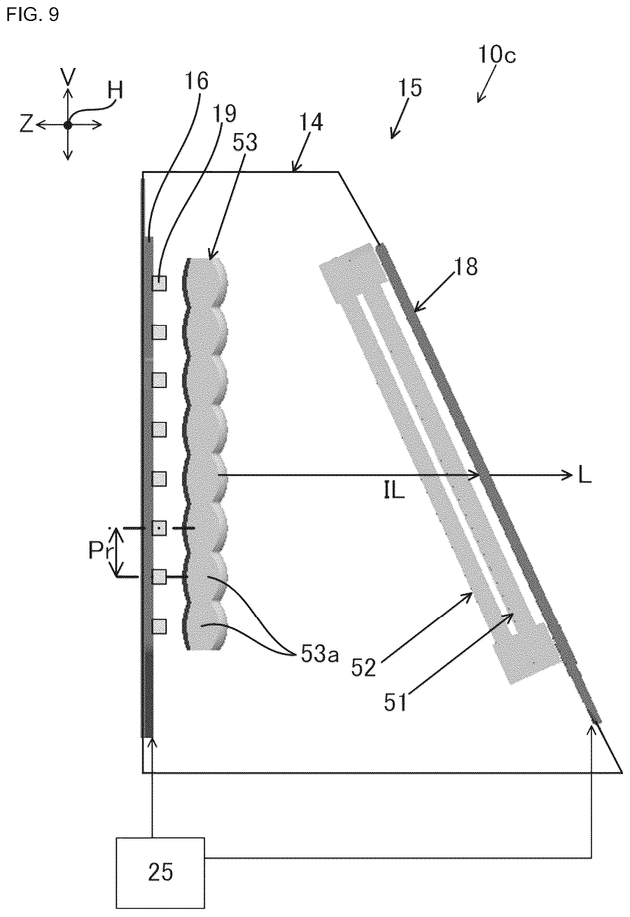

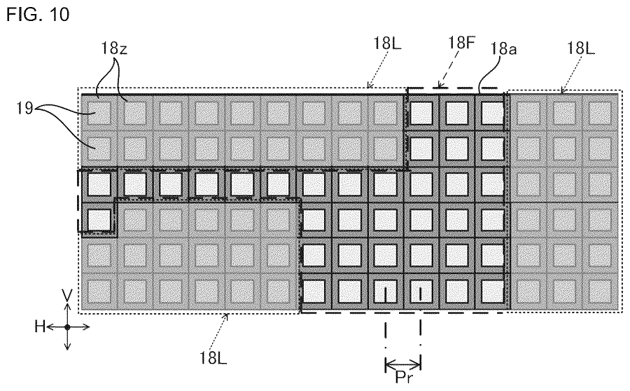

A display device 10c according to a comparative example and illustrated in FIGS. 9 and 10 does not include the monochrome liquid crystal panel 12. Therefore, in this comparative example, to suppress halation at the outer peripheral portion of the image display area as in the present embodiment, the same numbers of light sources 19 and convex lens portions 53a as the number of pixels of the monochrome liquid crystal panel 12 are required. Therefore, in this comparative example, it is necessary to decrease the arrangement interval of the light sources 19 and to make the pitch Pr of the convex lens portions 53a and the pitch Pr of the light sources 19 finer. The pitch Pr in FIG. 10 according to the comparative example is finer than the pitch Pr in FIG. 7 according to the present embodiment. For example, the pitch Pr in FIG. 7 according to the present embodiment is 10 to 12 mm, whereas the pitch Pr in FIG. 10 according to the comparative example is about 5 mm. It is known that the finer the pitch Pr, the lower the light utilization efficiency, which is the efficiency of the luminance of the dimming zone 18z relative to the power consumption of the light source 19. On the other hand, increasing the pitch Pr does not reduce the light utilization efficiency, but causes halation at the outer peripheral portion of the image display area and thus reduces the image contrast. As described above, it is difficult to increase the light utilization efficiency while increasing the image contrast.

The present embodiment has been made in consideration of the above-described circumstances, and an object thereof is to provide a display device and a head-up display device that can more appropriately increase image contrast in accordance with the shape of a display image.

To achieve the above object, the present embodiment discloses, for example, the following technical ideas (1) to (3).
(1) The display device 10b, includes the illumination device 15 that emits the illumination light IL, the liquid crystal display panel 18 that is an example of a display panel that includes the image display area 18b where an image is displayed and the non-display area 18c where no image is displayed, and that receives the illumination light IL and emits the display light L, and the monochrome liquid crystal panel 12 that is an example of a light-transmission/light-blocking switching panel that is located between the illumination device 15 and the liquid crystal display panel 18, and that sets, to a light-blocking state (e.g., the black display state Sb), an area corresponding to the non-display area 18c and sets, to a light-transmitting state (e.g., the white display state Sw), an area corresponding to the image display area 18b.
According to this configuration, even if the illumination device 15 does not have a local dimming function, the monochrome liquid crystal panel 12 can operate to increase the image contrast more appropriately in accordance with the shape of the display image.
(2) The illumination device 15 has a local dimming function for adjusting brightness of each of the plurality of dimming zones 18z.
According to this configuration, the image contrast is improved not only by the operation of the monochrome liquid crystal panel 12 but also by difference in luminance of the light sources 19.
In addition, according to this configuration, using the monochrome liquid crystal panel 12 allows the image contrast to be increased without increasing the number of light sources 19 and the number of the convex lens portions 53a. Thus, decrease in light utilization efficiency can be suppressed. Furthermore, by suppressing decrease in light utilization efficiency, it is possible to achieve power saving in the display device 10b.
(3) The monochrome liquid crystal panel 12 includes the plurality of pixels 12a arranged to form a number of matrices, and each of the plurality of pixels 12a has a small size compared to the plurality of dimming zones 18z. Each of the plurality of pixels 12a of the monochrome liquid crystal panel 12 is separately switchable between the light-blocking state (the black display state Sb) and the light-transmitting state (the white display state Sw).
According to this configuration, a general-purpose monochrome liquid crystal panel 12 can be used.
(4) The head-up display device 100 projects, onto the windshield 201 being a projection target member, the display light L emitted by the display device 10b, to display a projection image (the virtual image W) being an enlarged representation of an image displayed on the liquid crystal display panel 18.
According to this configuration, in the head-up display device 100, an image displayed on the liquid crystal display panel 18 is a reduced representation of the virtual image W, and thus a fine pitch Pr tends to be set for the light source 19 and the convex lens portion 53a and the light utilization efficiency may decrease. Therefore, using a monochrome liquid crystal panel 12 in the head-up display device 100 to increase the image contrast without using a reduced pitch Pr for the light source 19 and the convex lens portion 53a, is more advantageous compared to a direct-view television or monitor.

### Second Embodiment

A display device and a head-up display device according to a second embodiment of the present disclosure will be described with reference to the drawings. The present embodiment differs from the first embodiment in that the image display area 18b and the white display state Sw are offset from each other by a predetermined offset amount G to improve the luminance efficiency. The following description will focus on the differences from the first embodiment.

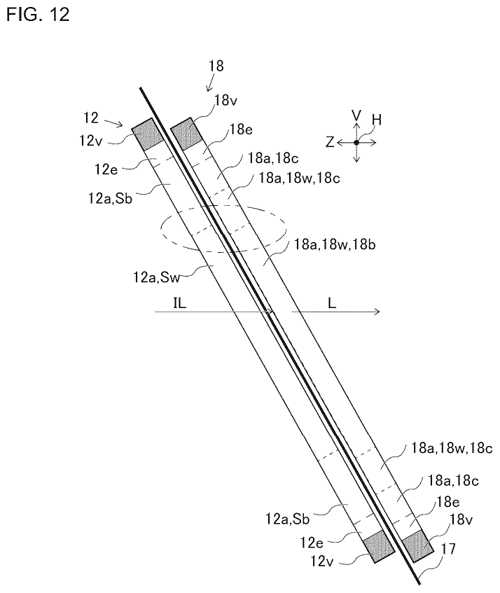

As illustrated in FIG. 12, the display device includes the monochrome liquid crystal panel 12, the light diffusing member 17, and the liquid crystal display panel 18.

The monochrome liquid crystal panel 12 is a monochrome liquid crystal panel, and a bezel 12v that surrounds the outer edges of a panel part is formed. The panel part includes a non-pixel portion 12e located on the outside and the plurality of pixels 12a located inside the non-pixel portion 12e and arranged in the vertical direction V and the horizontal direction H to form a matrix (so-called active area). The light-transmitting/light-blocking state of the pixels 12a is switchable between the white display state Sw and the black display state Sb in accordance with the image display area 18b and the non-display area 18c. The panel part and the pixels 12a both have a rectangular plate shape.

The liquid crystal display panel 18 is a full-color TFT panel, and a bezel 18v that surrounds the outer edges of a panel part is formed. The panel part includes a non-pixel portion 18e located on the outside and the display surface 18a (so-called active area) located inside the non-pixel portion 18e. The display surface 18a includes a plurality of pixels arranged in the vertical direction V and the horizontal direction H to form a matrix. The display surface 18a includes the image display area 18b and the non-display area 18c. The panel part and the display surface 18a have a rectangular plate shape.

The liquid crystal display panel 18 (particularly the display surface 18a) is held to be parallel to the monochrome liquid crystal panel 12 (particularly the pixels 12a) and is inclined at an angle θ with respect to the parallel light traveling direction Z. The liquid crystal display panel 18 is inclined such that when the angle θ is decomposed into a component in the vertical direction V and a component in the horizontal direction H, the angle θ has only the component in the vertical direction V. For example, the angle θ is 30 degrees. However, the angle θ may be changed appropriately in a range from 1 degree to 80 degrees. Note that the liquid crystal display panel 18 may be inclined such that the angle θ has only a component in the horizontal direction H, or may be inclined such that the angle θ has both components. The inclination of liquid crystal display panel 18 suppresses stray light from outside and enables display of an inclined virtual image W that is easy to view.

The range of the image display area 18b is changed as needed within a warping area 18w. For example, the image display area 18b can be changed in accordance with change in the content to be displayed, adjustment of the eyebox, change in warping parameters associated with the rotation of the second mirror, and the like.

That is, although the liquid crystal display panel 18 can physically perform image display within the display surface 18a, in normal use, the liquid crystal display panel 18 performs image display only within the warping area 18w. Note that an image may be temporarily displayed on a part of the display surface 18a outside the warping area 18w for testing, inspection, adjustment, and the like. Therefore, even if the pixels 12a occupy an area smaller than the display surface 18a, it is sufficient that the pixels 12a are provided to cover at least the area corresponding to the warping area 18w. In this case, the monochrome liquid crystal panel 12 may be held such that the areal center of the warping area 18w substantially coincides with the areal center of the pixels 12a in a plan view in the parallel light traveling direction Z or in a plan view in the normal direction of the display surface 18a. This configuration can reduce the size of the monochrome liquid crystal panel 12 as much as possible, and thus cost reduction can be achieved.

Alternatively, the monochrome liquid crystal panel 12 may be held such that the pixels 12a cover the warping area 18w in a plan view in the parallel light traveling direction Z and the areal center of the warping area 18w and the areal center of the pixels 12a are aligned with each other in the vertical direction V. According to this configuration, the positioning locations of the panels in the horizontal direction H are the same, and thus the positioning can be performed relatively easily.

Alternatively, the monochrome liquid crystal panel 12 may be held such that the pixels 12a cover the warping area 18w in a plan view in the parallel light traveling direction Z and the areal center of the warping area 18w and the areal center of the pixels 12a are aligned with each other in the horizontal direction H. According to this configuration, the positioning locations of the panels in the vertical direction V are the same, and thus the positioning can be performed relatively easily.

Alternatively, the monochrome liquid crystal panel 12 may be held such that the pixels 12a cover the warping area 18w in a plan view in the parallel light traveling direction Z and the areal center of the display surface 18a substantially coincides with the areal center of the pixels 12a in a plan view in the parallel light traveling direction Z or in a plan view in the normal direction of the display surface 18a. According to this configuration, the panels have the same center position, and thus the positioning can be performed easily.

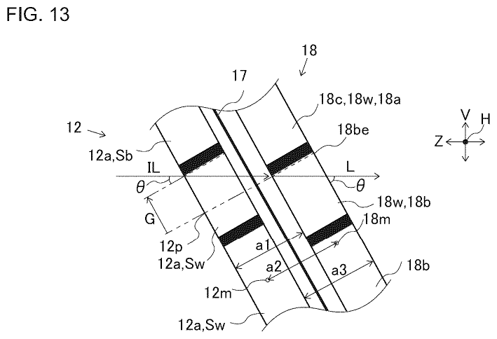

Here, a preferred example of the relative position between the white display state Sw and the image display area 18b will be described with reference to FIG. 13, which is an enlarged view of the part enclosed by the dash-dot-dot line in FIG. 12. Of a plurality of light beams included in the illumination light IL and the display light L, light beams close to the boundary with respect to the non-display area 18c are illustrated as representatives.

The white display state Sw is displayed such that a portion thereof corresponding to an end portion 18be of the inclined image display area 18b, which is an end portion closer to the light source 19, is offset by an offset amount G in an in-plane direction of the surface formed by the pixel 12a. Specifically, when a point where a normal line (dash-dot-dot line) extending from a point where the illumination light IL is incident on the image display area 18b meets the pixel 12a is defined as a corresponding point 12p, the white display state Sw is displayed to be offset by the offset amount G from the corresponding point 12p.

The offset amount G is at least greater than 0 mm. More preferably, the offset amount G is greater than the length of a single pixel of the pixels 12a.

From another viewpoint, the offset amount G is determined based on a*tan θ. Here, the constant a may be a distance from a point between an incident surface and an exit surface of the monochrome liquid crystal panel 12 to a point between an incident surface and an exit surface of the liquid crystal display panel 18. A length al illustrated as a representative example of the constant a is the distance between the incident surfaces of the panels. Similarly, a length a2 illustrated as another representative example is the distance between the middle points of the panels in the thickness direction. Similarly, a length a3 illustrated as another representative example is the distance between the exit surfaces of the panels. “tan” means “tangent”. To align the openings of the pixels with each other, as illustrated in the figure, it is most preferable that the offset amount G is based on the length al.

Note that the direction of the offset by the offset amount G may not be the V direction. The direction of offset may be any of the in-plane directions as long as the direction is at least a direction approaching the light source 19 from the corresponding portion 12p. If the angle θ has both components in the vertical direction V and the horizontal direction H, the direction of the offset is preferably a direction approaching the light source 19 most.

Even if the liquid crystal display panel 18 is inclined in both the vertical direction V and the horizontal direction H, the direction of offset may be only one of the vertical direction V and the horizontal direction H. In this case, θ used to calculate the offset amount G may be calculated using a corresponding component of the angle θ (an angle θv, which is the component of the angle θ in the vertical direction V, and an angle θh, which is the component of the angle θ in the horizontal direction H).

Most preferably, the area of the white display state Sw coincides with the image display area 18b, in a plan view in the parallel light traveling direction. The offset amount allowing a wider display may be used. In this case, a relatively large amount of illumination light IL reaches the non display area 18c, and thus the contrast slightly decreases. Therefore, when the white display state Sw is displayed more widely than the image display area 18b by a predetermined lap amount in the plan view, it is most preferable that this lap amount is set to be less than the length of one pixel 12a. This allows sufficient illumination to the image display area 18b to be provided while minimizing unnecessary illumination to the non-display area 18c.

The present embodiment has been made in consideration of the above-described circumstances, and an object thereof is to provide a display device and a head-up display device that can appropriately increase image contrast in accordance with the shape of a display image while improving luminance efficiency.

Note that the present disclosure is not limited to the above-described embodiments and drawings. Appropriate modifications (including deletion of components) may be made without departing from the spirit of the present disclosure. Example variations will be described below.

### Variations

In each of the above embodiments, the head-up display device 100 is configured as a cross optical system in which the display light L reflected by the first mirror 21 does not cross in the horizontal direction H but crosses in the vertical direction V at the cross point CP. However, the head-up display device 100 may be configured as a non-cross optical system.

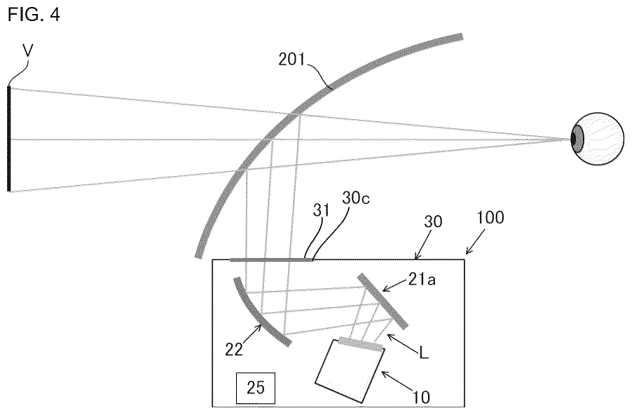

When a non-cross optical system is employed, as illustrated in FIG. 4, the first mirror 21a may be configured as a plane mirror, and the display light L reflected by the first mirror 21a may not cross in the vertical direction V and the horizontal direction H. Furthermore, the first mirror 21a is not limited to a plane mirror, but may be a convex mirror. Further, the first mirror 21, 21a may be omitted, and the display light L from the display device 10 may be directly projected onto the second mirror 22.

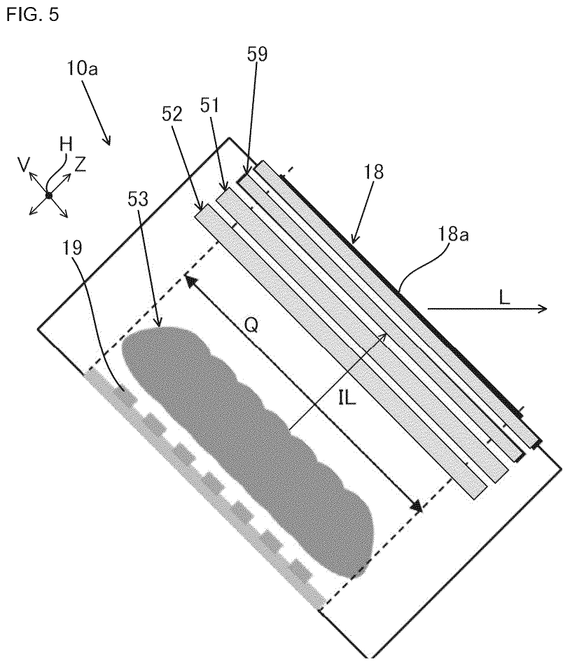

In each of the above embodiments and the variation, the first lens 51 is inclined non-perpendicularly with respect to the optical axes of the illumination light IL and the display light L, but the present disclosure is not limited to this configuration. Thus, the direction of light may be changed using a prism sheet (an optical path changing means) such that the optical axis of the illumination light IL is perpendicular to the first lens 51 and the optical axis of the display light L is inclined non-perpendicularly with respect to the first lens 51. For example, as illustrated in FIG. 5, a prism sheet 59 is arranged between the first lens 51 and the liquid crystal display panel 18, and includes minute prisms that reflect the illumination light IL in a direction different from the parallel light traveling direction Z. The prism sheet 59 is not limited to being located between the first lens 51 and the liquid crystal display panel 18, but may be located between the first lens 51 and the second lens 52, or between the second lens 52 and the third lens 53. By using the prism sheet 59, the size of the display device 10a can be reduced. Furthermore, by using the prism sheet 59, an illumination size Q may be increased without changing the size of the intermediate image displayed on the display surface 18a. Therefore, in the local dimming function, the number of dimming zones can be increased without changing the pitch of the light sources 19.

In the above embodiments, the first to third lenses 51 to 53 are each formed in a rectangular plate shape, but are not limited to being formed in that shape, and may be formed in a square, circular, elliptical, or polygonal plate shape, for example.

In the above embodiments, the head-up display device 100 is mounted on the vehicle 200, but is not limited to being mounted on the vehicle 200, and may be mounted on another vehicle such as an aircraft or a watercraft. The projection target member to which the display light L is projected is not limited to the windshield 201 and may be a dedicated combiner.

In the first embodiment described above, each of the pixels 12a of the monochrome liquid crystal panel 12 is switchable between the white display state Sw (light transmittance of 100%) and the black display state Sb (light transmittance of 0%), but may be switchable to a gray display state (e.g., light transmittance of 1% to 99%). This allows for a wide range of dimming. For example, a gradation may be applied to the outer peripheral portion of the image display area 18b.

In the first embodiment, the monochrome liquid crystal panel 12 may be provided between the light diffusing member 17 and the liquid crystal display panel 18.

In the first embodiment, the numbers of the convex lens portions 53a and light sources 19 may be increased or decreased.

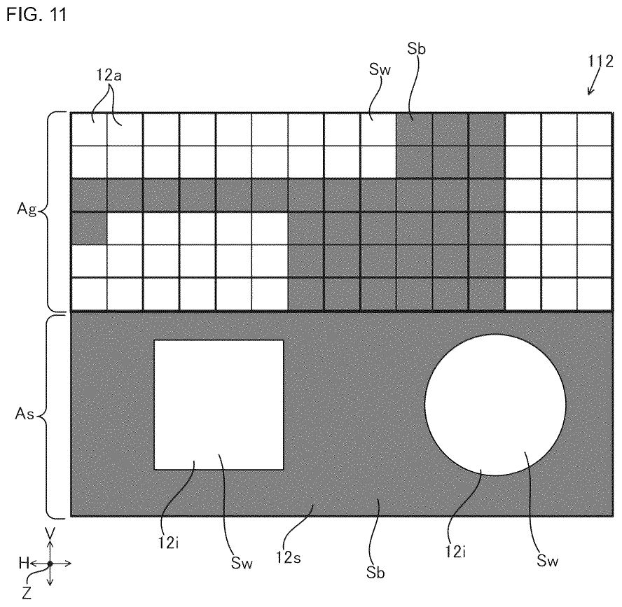

In the first embodiment described above, the monochrome liquid crystal panel 12 includes the plurality of pixels 12a arranged in the vertical direction V and the horizontal direction H, but instead of or in addition to the pixels 12a, the monochrome liquid crystal panel 12 may include a plurality of segments that are switchable between the white display state Sw and the black display state Sb. Specifically, as illustrated in FIG. 11, a monochrome liquid crystal panel 112 includes a segment area As including a plurality of segments 12s, 12i which are switchable between the white display state Sw and the black display state Sb. The segment 12s is set to the black display state Sb to be the background of the segment area As. The segment 12i is formed in the segment 12s in a polygonal or circular shape, and has a size larger than that of the pixel 12a. The segment 12i is set to the white display state Sw. The image display area 18b of the liquid crystal display panel 18 overlaps the segment 12i. As a result, an image is displayed in the segment 12i. In this example, the segment area As is located below a pixel area Ag including a plurality of pixels 12a. The lower part of the virtual image W displays certain information such as vehicle speed, legal speed limit, or remaining fuel, and the upper part of the virtual image W displays information that is more diverse and more variable compared to the lower part of the virtual image W, such as an arrow for route guide. Therefore, it is preferable that the segment area As corresponds to the lower part of the virtual image W, and the pixel area Ag corresponds to the upper part of the virtual image W.

The positional relationship between the segment area As and the pixel area Ag is not limited to that of this example, and the segment area As may be located above the pixel area Ag, or the segment area As and the pixel area Ag may be arranged side by side in the left-right direction. Alternatively, the entire area of the monochrome liquid crystal panel 112 may be formed by the segment area As. The pixel area Ag of the monochrome liquid crystal panel 112 may be omitted.

In the first embodiment and the variation described above, the monochrome liquid crystal panel 12, 112 is positioned to face the entire liquid crystal display panel 18 in the parallel light traveling direction Z, but may be positioned to face only a portion of the liquid crystal display panel 18 (for example, only the upper part of the liquid crystal display panel 18). In the first embodiment, the first to third lenses 51 to 53 are not limited to the configurations disclosed in the first embodiment, but may have any known lens configuration.

In the first embodiment, a color liquid crystal panel may be provided in place of the monochrome liquid crystal panel 12.

In the first embodiment, the first and second lenses 51 and 52, the monochrome liquid crystal panel 12, the light diffusing member 17, and the liquid crystal display panel 18 may be oriented perpendicularly to the parallel light traveling direction Z.

In the first embodiment, the illumination device 15 may not have a local dimming function.

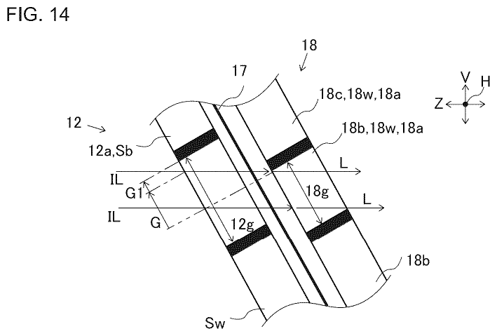

In the second embodiment, the pixels 12a and the pixels of the display surface 18a do not need to be identical in all of the size, pitch, and aperture ratio. For example, as illustrated in FIG. 14, a length 12g of a single pixel of the pixels 12a may be longer than a length 18g of a single pixel of the pixels of the display surface 18a, as long as the white display state Sw is displayed in an offset area as described above. The amount of offset is not necessarily equal to the calculated offset amount G, and an extra offset amount G1 may be added as illustrated in FIG. 14. The extra offset amount is preferably less than the length 12g. This configuration can prevent all of the illumination light IL that has passed through one of the pixels 12a in the white display state Sw from reaching the non-display area 18c, and thereby can suppress a decrease in contrast.

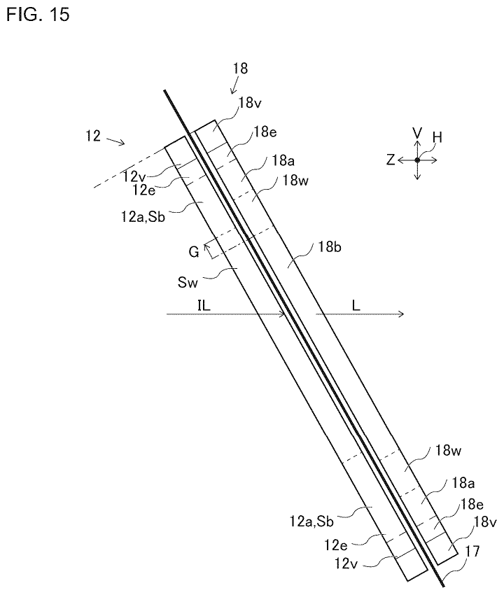

In the second embodiment, the monochrome liquid crystal panel 12 (the pixels 12a) may be held to have the same outer shape or the same areal center as the liquid crystal display panel 18 (display surface 18a) in a plan view in the normal direction (see FIG. 15). Such a configuration is allowed, as long as the white display state Sw with the offset is performed as described above. This configuration makes it possible to easily position each panel.

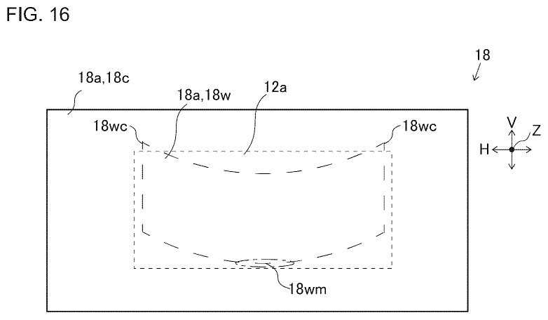

In the second embodiment, the pixels 12a may not fully cover the warping area 18w. For example, as illustrated in FIG. 16, the warping area 18w typically has a rectangular shape with the long sides curved in the vertical direction V, due to reflection on the windshield 201 and the like. When a rectangle formed by the pixels 12a covers such a warping area 18w, it is preferable that the pixels 12a at least cover a middle segment 18wm (within the dash-dot line) of each side. In other words, corners 18wc may protrude from the area covered by the pixels 12a. The liquid crystal display panel 18 used in a head-up display device typically displays an image with brightness in a part of a black background, and such an image with brightness is more likely to be displayed near the middle segment 18wm than near the corner 18wc. Therefore, it is preferable that the holding position of the pixels 12a is set to cover at least relatively important portions (the middle segments 18wm).

### REFERENCE SIGNS LIST

10, 10a, 10b, 10c . . . Display device
12 . . . Monochrome liquid crystal panel, 12a . . . Pixel
14 . . . Case, 14a . . . Opening portion
15 . . . Illumination device
16 . . . Substrate
17 . . . Light diffusing member
18 . . . Liquid crystal display panel, 18a . . . Display surface, 18b . . . Image display area, 18c . . . Non-display area, 18z . . . Dimming zone, 18F . . . Turned-off area, 18L . . . Turned-on area
19 . . . Light source
21, 21a . . . First mirror, 22 . . . Second mirror
25 . . . Control unit
30 . . . Housing, 30c . . . Opening portion, 31 . . . Window portion
51 to 53 . . . First to third lenses, 51i, 52i . . . Incident surface, 510, 520 . . . Exit surface, 53a . . . Convex lens portion
59 . . . Prism sheet
100 . . . Head-up display device
200 . . . Vehicle, 201 . . . Windshield
Sb . . . Biconic lens array surface, Sb1 . . . Microlens portion, Sc . . . Cylindrical lens surface, Sc1 . . . Cylindrical lens portion, Sf . . . Concentric Fresnel lens surface, Sf1 . . . Crest portion, Sf2 . . . Fresnel inclined surface, Sf3 . . . Side surface
SrH . . . Horizontal light distribution linear Fresnel lens surface, Sr1 . . . Crest portion, Sr2 . . . Fresnel inclined surface, Sr3 . . . Side surface
SrV . . . Vertical light distribution linear Fresnel lens surface, Sra . . . Crest portion, Srb . . . Fresnel inclined surface, Src . . . Side surface
H . . . Horizontal direction, V . . . Vertical direction, Z . . . Parallel light traveling direction, θ . . . Light distribution angle, α . . . Angle, C1, C2, C3 . . . Curvature,
J . . . Central plane, L . . . Display light, O . . . Central axis, P . . . Lens pitch, Q . . . Illumination size, R . . . Radial direction, W ... Virtual image, W1 . . . Arrangement direction, L1 . . . Extension direction, CP . . . Cross point, IL . . . Illumination light, Pr, Pg .. . Pitch, Sw . . . White display state, Sb . . . Black display state, As . . . Segment area, Ag . . . Pixel area

1. A display device, comprising:
an illumination device that emits illumination light;
a display panel that includes an image display area where an image is displayed and a non-display area where no image is displayed, and that receives the illumination light and emits display light; and
a light-transmission/light-blocking switching panel that is located between the illumination device and the display panel, and that sets, to a light-blocking state, an area corresponding to the non-display area and sets, to a light-transmitting state, an area corresponding to the image display area.

2. The display device according to claim 1, wherein
the illumination device has a local dimming function for adjusting brightness of each of a plurality of dimming zones.

3. The display device according to claim 2, wherein
the light-transmission/light-blocking switching panel includes a plurality of pixels arranged to form a number of matrices, each of the plurality of pixels having a small size compared to the plurality of dimming zones, and
each of the plurality of pixels of the light-transmission/light-blocking switching panel is separately switchable between the light-blocking state and the light-transmitting state.

4. The display device according to claim 1, wherein
the display panel and the light-transmission/light-blocking switching panel are inclined with respect to a traveling direction of the illumination light, and
one of end portions of the area corresponding to the image display area being an end portion closer to the illumination device is offset from a corresponding point being a point of intersection with a normal line extending from the image display area, in an in-plane direction toward the illumination device by a predetermined offset amount.

5. The display device according to claim 4, wherein
the light-transmission/light-blocking switching panel includes a plurality of pixels arranged to form a number of matrices, and
the offset amount is equal to or greater than a length of a single pixel of the plurality of pixels.

6. The display device according to claim 4, wherein
the display panel and the light-transmission/light-blocking switching panel each have a rectangular plate shape and are parallel to each other,
the offset amount is determined based on a value of any one of a*tan(θ), a*tan(θx), or a*tan(θy),
a is a distance in a direction of the normal line from a point between an incident surface and an exit surface of the light-transmission/light-blocking switching panel to a point between an incident surface and an exit surface of the display panel,
θ is the inclination angle of the display panel and the light-transmission/light-blocking switching panel with respect to the traveling direction,
θx is a component in a short side direction of the display panel, of the inclination angle of the display panel and the light-transmission/light-blocking switching panel with respect to the traveling direction, and
θy is a component in a long side direction of the display panel, of the inclination angle of the display panel and the light-transmission/light-blocking switching panel with respect to the traveling direction.

7. A head-up display device for projecting, onto a projection target member, the display light emitted by the display device according to claim 1, to display a projection image being an enlarged representation of an image displayed on the display panel.
